(19) United States
(12) Patent Application Publication
(10) Pub. No.: US 2004/0203633 A1
(43) Pub. Date: Oct. 14, 2004

(54) Provision of information regarding transaction assistance availability

(76) Inventors: Robert C. Knauerhase, Portland, OR (US); Nikhil M. Deshpande, Beaverton, OR (US); Du V. Nguyen, Tigard, OR (US); Uttam Sengupta, Portland, OR (US)

Correspondence Address: Blakely, Sokoloff, Taylor & Zafman, Seventh Floor, 12400 Wilshire Boulevard, Los Angeles, CA, 90025-1030, US

(21) Appl. No.: 10/112,388

(22) Filed: Mar. 28, 2002

(51) Int. Cl. H04Q 7/20

(52) U.S. Cl. 455/414.1; 455/466

(57) ABSTRACT

According to the invention, the provision of information regarding transaction assistance availability in a transaction environment is disclosed. According to an embodiment, a method comprises determining the location of a mobile device; determining the availability of transaction assistance; and transmitting information regarding availability of transaction assistance to the mobile device.

### COPYRIGHT NOTICE

Contained herein is material that is subject to copyright protection. The copyright owner has no objection to the facsimile reproduction by anyone of the patent document or the patent disclosure, as it appears in the United States Patent and Trademark Office patent file or records, but otherwise reserves all rights to the copyright whatsoever. The following notice applies to the software and data as described below and in the drawings hereto: Copyright© 2002, Intel Corporation, All Rights Reserved.

### FIELD

An embodiment of the invention relates to communications in general, and more specifically to provision of information regarding transaction assistance availability to transactants in a transaction environment.

### BACKGROUND

In conventional transaction environments, including environments in which retail sales are made, a transactant generally must seek out and determine the current situation regarding assistance availability. For example, while certain information regarding the location of transaction stations, such as cash registers, may be available, a transactant, such as a retail customer, generally is required to find the registers, determine the length of check out lines, and estimate the waiting period required for check-out in order to determine the quickest and most efficient method of completing a transaction.

In certain large transaction environments, such as a large retail store with multiple floors, there may be multiple cash registers in different locations, making it difficult for a customer to determine how to best proceed. Further, what sales assistance there is may be spread throughout a large area, possibly making it inconvenient to find assistance when needed.

There are also environments, such as shopping malls, in which numerous retailers are in close proximity. However, it is generally necessary for a customer to physically enter the premises of each retailer to determine whether there is a large number of customers who are waiting to complete purchases. In conventional settings, a transactant does not receive sufficient information regarding the status of transaction assistance availability to enable the transactant to make the most efficient use of the transactant's limited time for considering and completing transactions.

### BRIEF DESCRIPTION OF THE DRAWINGS

The invention may be best understood by referring to the following description and accompanying drawings that are used to illustrate embodiments of the invention. In the drawings:

FIG. 1 illustrates a possible transaction environment in which an embodiment of the invention may be utilized;

FIG. 2 illustrates the determination of the location of a mobile client device under an embodiment of the invention;

FIG. 3 is an illustration of transaction assistance information that may be displayed under an embodiment of the invention;

FIG. 4 is an illustration of the determination of the number of transactants waiting for checkout under an embodiment of the invention;

FIG. 5 illustrates a transaction environment including multiple sales establishments under an embodiment of the invention;

FIG. 6 is a block diagram showing the operation of an embodiment of the invention; and

FIG. 7 is a block diagram illustrating an exemplary mobile client device that may be utilized in connection with an embodiment of the invention.

### DETAILED DESCRIPTION

A method and apparatus are described for provision of information regarding transaction assistance availability to transactants in a transaction environment.

In the following description, for the purposes of explanation, numerous specific details are set forth. However, it is understood that embodiments of the invention may be practiced without these specific details. In other instances, well-known circuits, structures, techniques, and devices have not been shown in detail in order not to obscure the understanding of this description.

Embodiments of the invention include various processes, which will be described below. The processes may be performed by hardware components or may be embodied in machine-executable instructions, which may be used to cause a general-purpose or special-purpose processor or logic circuits programmed with the instructions to perform the processes. Alternatively, the processes may be performed by a combination of hardware and software.

### Terminology

Before describing an exemplary environment in which various embodiments of the present invention may be implemented, some terms that will be used throughout this application will briefly be defined:

As used herein, “mobile client device” means any device that is mobile and that is capable of communication functions. A mobile client device includes, but is not limited to, a personal digital assistant (PDA) with communication functions; a mobile computer with wireless network access; a cellular telephone; a computer installed in a motor vehicle that may be connected to a network; and other such devices.

As used herein, “transaction environment” means any area or facility in which or near which economic transactions are conducted, including, but not limited to, a store, a shopping mall, a group of stores located in a particular geographic region, and a facility in which services are obtained.

As used herein, “transactant” means a person who is in a transaction environment or who desires to engage in a transaction. The term includes, for example, a customer in a retail store.

As used herein, “transaction assistant” means a human clerk, a machine, an automated system, or other assistant that provides assistance to transactants. The term includes, but is not limited to, a salesperson or sales clerk who may assist retail customers or a transaction station for a transaction environment.

As used herein, “transaction station” means a location in a transaction environment at which transactions may be made. The term includes, for example, a location where a cash register is located and sales items may be purchased.

As used herein, “sales item” means any product, service, material or other item that may be purchased, leased, or otherwise obtained in a transaction environment.

Under an embodiment of the invention, a transactant in a transaction environment is in possession of a mobile client device. The location of the mobile client device in the transaction environment is determined. The location may be made by any method, including, for example, global positioning satellite (GPS) location, radio triangulation, or hotspot detection. Upon determination of the location of the mobile client device, information regarding transaction assistance availability is pushed to the device.

Under an embodiment of the invention, the information regarding transaction assistance availability is in the form of dynamic information regarding which transaction stations are open, the number of transactants waiting or otherwise in queue at each transaction station, and the estimated waiting time for each transaction station. Under an embodiment of the invention, the information is in the form of information regarding which salespeople are available to assist the transactant. The information regarding the availability of transaction assistance may be provided to transactants to enable more efficient and effective economic commerce. Increased knowledge of available transaction assistance may be utilized to enable a consumer to make more efficient use of time for shopping and completing transactions.

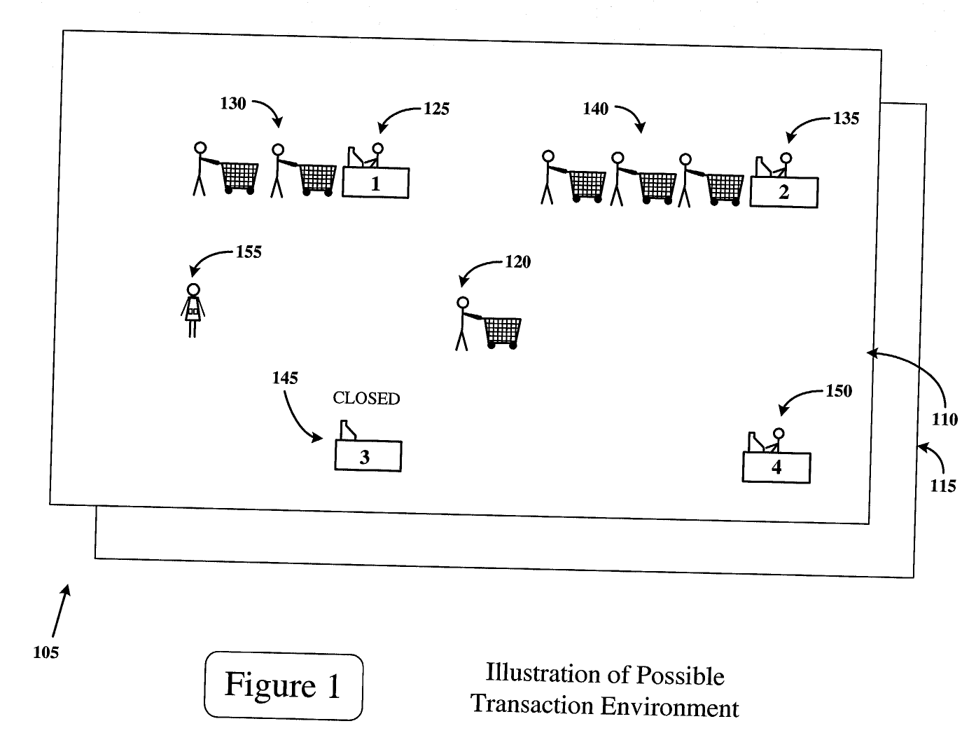

FIG. 1 is an illustration of a possible transaction environment in which an embodiment of the invention may be employed. A retail store 105 may include multiple levels or floors, shown here as a first level 110 and a second level 115. In this example, a customer 120 may wish to purchase selected items. However, the customer may have multiple options for completing the sales transaction. In this example, the store 105 has transaction stations in the form of four separate cash register stations. In FIG. 1, a first cash register station 125 has two customers waiting 130, while a second cash register station 135 has three customers 140 waiting in line. In this example, a third cash register station 145 is currently closed, and a fourth cash register station has no customers waiting. In addition, there could be other cash register stations located on the second level 115. Generally it is difficult for customer 120 to assess the situation and find the cash register line that is the shortest without actually traveling to each of the cash register stations and determining the length of the check out line for each register. In addition, the customer 120 may require some other transaction assistance. In this example, one or more salespeople 155 may be present in retail store 105, but may again be difficult for customer 120 to locate.

Under an embodiment of the invention, the transactant may also request transaction assistance. In one embodiment, a transactant who is located in a particular area of a transaction environment may request assistance by entering the request in a mobile client device. In response to such request, the transactant may, for example, receive information regarding the availability of clerks to assist with transactions, including whether the clerks in the area are free to assist or currently working with other transactants. In one embodiment of the invention, the system may relay the request to one or more clerks who are located in the vicinity of the transactant. A clerk who is available may then, based at least in part on the location of the transactant, go directly to the transactant to provide assistance without the transactant being required to find the clerk.

Under one embodiment, information regarding the transaction assistance availability that has been provided via a mobile client device is deleted from the mobile client device upon a determination that the mobile client device is no longer in the vicinity of the transaction environment. Under one embodiment of the invention, a transaction environment may be comprised of multiple areas or sectors. Upon a determination that a mobile client device in the possession of a transactant is located in a first area in the transaction environment, information regarding transaction assistance availability for the first area is provided via the mobile client device. Upon a determination that the mobile client device has moved from the first area in the transaction environment to a second area in the transaction environment, the information regarding transaction assistance availability for the first area is deleted and information regarding transaction assistance availability for the second area is provided via the mobile client device.

The determination of the location of a mobile client device varies according to the particular embodiment of the invention and may be performed by any known method. Embodiments of the invention may utilize many different types of communication technology, including, but not limited to, a wireless local area network (WLAN), such as a WLAN under Institute of Electrical and Electronics Engineers (IEEE) standard 802.11 b for wireless local area networks (IEEE, September 1999); other wireless technologies, such as Bluetooth protocol systems; cellular telephone technologies; and other communications technologies. In a particular embodiment, a WLAN may be implemented. In such embodiment, the mobile client device communicates with the WLAN through one or more access points (AP) and the location of the mobile client device may be determined via proximity to the access points. Under an embodiment utilizing a WLAN, a network interface card (NIC) may be installed in the mobile client device and the NIC utilized to enable communication with one or more access points once the mobile client device enters a transaction environment.

According to an embodiment of the invention, a transactant who is in possession of a mobile client device may enter a particular current location into the device. The entered location may provide an indication that the device is, for example, located within a particular store, a particular department of a store, or a particular sector of a shopping mall, or is located in some other relevant position. The entered location is transmitted to a transaction assistance system and transaction assistance availability information is then provided to the transactant based at least in part on the entered location. If the transactant moves to a new location, such as a different store, department, or shopping mall sector, the transactant may enter the new location into the mobile client device in order to receive transaction assistance information that is relevant to the new location.

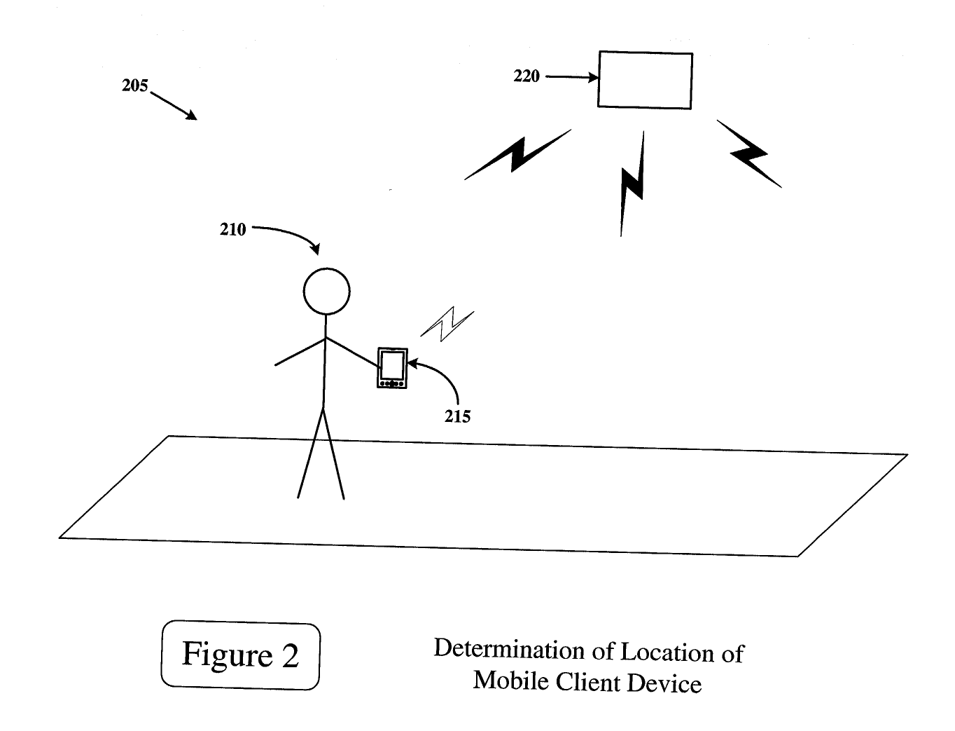

FIG. 2 illustrates the detection of the location of a transactant under an embodiment of the invention. Under this embodiment, a transactant 210 is within a transaction environment 205, such as a retail store. The transactant 210 has a mobile client device 215 in the transactant's possession. The device shown in FIG. 2 is shown as a personal digital assistant for simplicity, but any mobile client device may be utilized. The location of the mobile client device 215 may be determined in various ways. According to one embodiment, a connection point, which in this example is an access point 220 of a wireless local area network, detects that the mobile client device 215 is located in the vicinity of the access point 220. According to another embodiment, the mobile client device 215 may detect the presence of the access point 220 and may inform the system infrastructure regarding the location of the mobile client device 215. In FIG. 2, only one connection point is shown, but multiple connection points may be present in a transaction environment. Under certain embodiments, multiple access points in a transaction environment may be utilized to determine, for example, a location on one of the floors of a store, within one of a number of different departments of a store, or within one of a number of stores in a shopping mall.

Under an embodiment of the invention, a system to provide information regarding transaction assistance is implemented as a part of an instant messaging system. Under such embodiment, information regarding transaction assistance may be provided to a mobile client device in the form of a “buddy list” of potential contacts. For example, the information regarding transaction stations or other transaction assistants available to provide assistance may be pushed to a mobile client device as an expansion of an existing buddy list or as a new buddy list for the device. In an instant messaging system, the information system could track the presence information of each transaction assistant. In a particular embodiment, the concept of presence in an instant messaging system is expanded to include dynamic data regarding the availability of transaction assistance. Under one embodiment, the presence information for a transaction station includes data regarding the number of transactants waiting for service and the estimated waiting time at the transaction station. Under another embodiment, the concept of presence may also be expanded to include the physical location of a mobile transaction assistant in a transaction environment. However, the invention may be implemented using numerous different systems and technologies and is not limited to an instant messaging system.

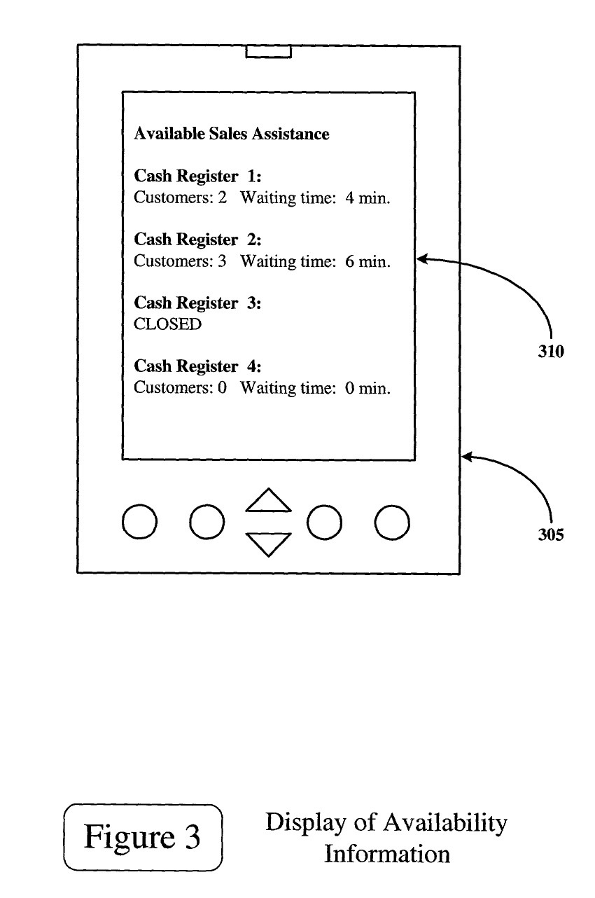

FIG. 3 is an illustration of an information display for a transactant, as produced on a PDA or other mobile client device, which is a possible example of a method of providing information to a transactant under an embodiment of the invention. The mobile client device 305 shows a possible information display 310 regarding the retail environment shown in FIG. 1. In the information display 310, the status of each of the four cash registers is shown. The user of the mobile client device 305 receives information indicating that the third cash register station is closed. For the remaining open cash register stations, the user receives information indicating how many transactants are currently in line for check out and the estimated waiting time for each open cash register. Using this information, the user of the mobile client device 305 can go directly to the cash register with the shortest line. In this way, the transactant reduces the amount of time spent in line. Further, the store may be able to provide more consistent work conditions for the employees operating cash register stations because transactants can use their knowledge of transaction assistance availability to choose the cash register stations that are under-utilized and avoid the cash register stations that are over-utilized. FIG. 3 illustrates one method by which information regarding transaction assistance availability may be provided, but other methods may also be used. Under other embodiments, such information may be provided in audio form or in any other communicative format.

Under a particular embodiment, one or more transaction assistants are not located at transaction stations, but are mobile and may be located at multiple locations throughout a transaction environment. Under this embodiment, information regarding the physical location and availability of the mobile transaction assistants may be determined and provided dynamically to a transactant. Under one embodiment, each transaction assistant also has a mobile client device. Under one embodiment, the location of each transaction assistant is automatically determined, such as by location detection in a wireless local access network. Under one embodiment, availability of a particular transaction assistant may be determined by the transaction assistant entering information into the transaction assistant's mobile client device indicating that the transaction assistant is currently in the process of helping a transactant or indicating that the transaction assistant is available to assist a transactant. In some embodiments, the mobile transaction assistants may be able to complete a sale without directing the transactant to a transaction station.

Under some embodiments of the invention, transaction assistants may include automated sales devices as well as human personnel. In one example, the transaction assistant may be in the form of a scanning machine and check out system in which a transactant scans items to be purchased, pays with cash, a credit or debit card, or by some other automated means, and obtains a receipt from the system without intervention by a human transaction assistant. In one embodiment, a transactant may be provided with information regarding the availability of automated sales machines, the number of transactants waiting at such machines, and the estimated waiting time at such machines.

The determination of the availability of transaction assistance may be accomplished by various means dependent on the embodiment of the invention. Under one embodiment, one or more sensors may determine the number of transactants in a line at a transaction station. Under another embodiment, a salesperson in a retail store may input the number of people in line prior to beginning each sales transaction. Under another embodiment, a salesperson enters the number of customers waiting in line periodically when prompted, with the prompting possibly being made in response to a customer making an inquiry regarding the status of each transaction station.

Under a particular embodiment, the availability of transaction assistance at transaction stations may be determined by sensing how many mobile client devices are in the vicinity of each transaction station. If all or a large portion of transactants in a transaction environment have mobile client devices, then the sensing of mobile devices will provide a good estimate of the number of transactants waiting in line. In one embodiment, a retail establishment may provide mobile devices for the use of transactants while the transactants are in the establishment. Under another embodiment, the number of shopping carts and shopping baskets in the vicinity of a transaction station may be detected. In one particular embodiment, each shopping cart and shopping basket may contain a transponder or other device to enable detection.

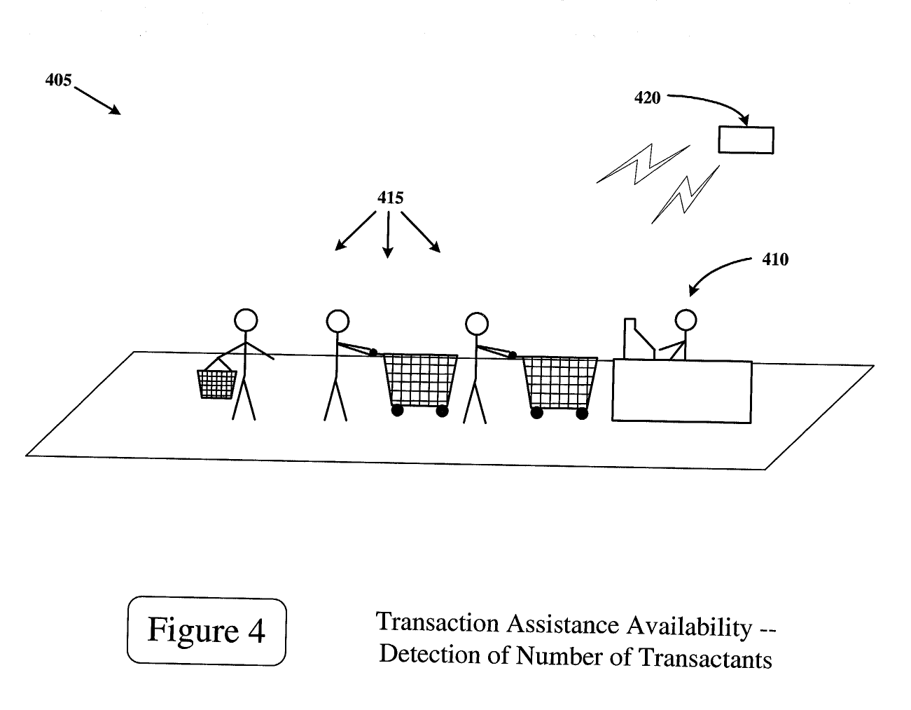

FIG. 4 is an illustration of determination of information regarding transactants waiting for service at a transaction station. Under an embodiment of the invention, a transaction environment 405 includes a transaction station in the form of a cash register station 410. Multiple customers 415 are in line waiting to check out at the cash register station 410. According to an embodiment of the invention, a sensor 420 determines the number of customers 415 in line at the cash register station 410. The sensor 420 may determine the number of customers in line by various methods depending on the embodiment. The sensor 420 may detect the number of shopping carts and shopping baskets in the vicinity. In an embodiment in which all or a large percentage of the customers in transaction environments are in possession of mobile client devices, the sensor 420 may detect the number of mobile client devices in the vicinity. In another embodiment, sensor 420 may be placed in the floor of the transaction environment and estimate the number of customers by the length of the line of customers.

Under various embodiments of the invention, an estimated time that a transactant may need to wait in a line at a transaction station may be determined in a variety of ways. In one embodiment, an average wait time per transactant is estimated beforehand and is multiplied by the number of transactants who are waiting. In another embodiment, a dynamic estimate of the waiting time may be calculated by computing the actual waiting time at a particular transaction station for each transactant and using this data to calculate a more accurate estimate of the current waiting time.

Under a particular embodiment, a transaction environment comprises an indoor or outdoor shopping mall or similar environment where multiple stores are in close proximity. Under an embodiment, a system is implemented that enables the stores in a shopping mall to inform customers of regarding which stores currently have available transaction assistance. The transaction assistance information may be combined with other information regarding the stores and regarding the merchandise that is available in each store.

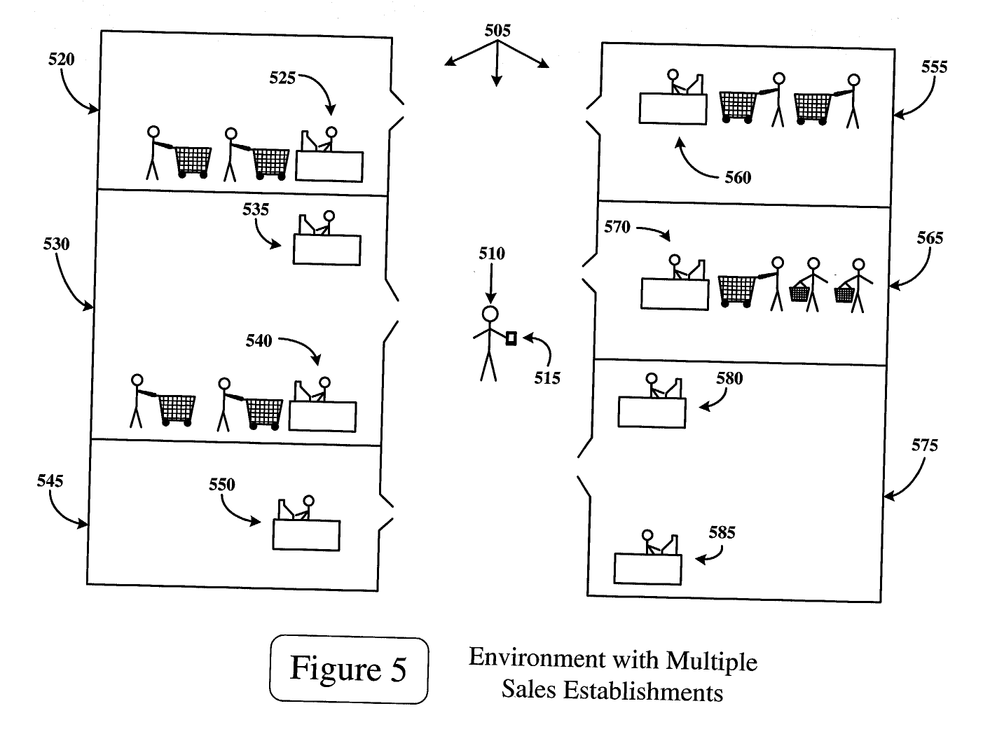

In FIG. 5, an embodiment of the invention is shown in a transaction environment comprising multiple retail stores, such as a shopping mall. In a shopping mall environment 505, a customer 510 with a mobile client device 515 is in the vicinity of a number of different retail stores. As shown in FIG. 5, each store has one or more transaction stations, which in this example are shown as cash register stations. The transaction stations have varying availability. A first store 520 has one cash register station 525 with two customers waiting. A second store 530 has a first cash register station 535 with customers waiting and a second cash register station 540 with two customers waiting. A third store 545 has a one cash register station 550 with no customers waiting. A fourth store 555 has one cash register station 560 with two customers waiting. A fifth store 565 has one cash register station 570 with three customers waiting. A sixth store 575 has a first cash register station 580 with no customers waiting and a second cash register station 585 with no customers waiting. In addition to other information that may be provided regarding the stores, information regarding the availability of sale assistance at each of the stores could be pushed to the mobile client device 515. Under one embodiment of the invention, information could be provided regarding the number of customers waiting in line at each cash register station in each store and the average waiting time at each such cash register station. Using this information, the customer 510 could make a decision regarding which retail establishment to visit at what time. The information benefits the customer 510, who can make the most efficient use of shopping time by visiting stores while the stores are less crowded. The information may benefit the stores by attracting customers who prefer efficient shopping and by encouraging customers to conduct business when the stores have a lower number of customers, thereby allowing the stores to make the most efficient use of their personnel.

Embodiments of the invention may include many other types of transaction environments. Under one embodiment of the invention, a transaction environment may include one or more automatic parking lots or parking structures. On entering the region, the location of a mobile client device in a motor vehicle may be detected. Information regarding parking may be provided via the mobile client device, including, for example, transaction assistance information in the form of information regarding the availability of parking pay stations, the number of vehicles or persons waiting at each parking pay station, and the estimated waiting time for each parking pay station. Under various embodiments of the invention, parking pay stations may include, for example, parking garage entrances and available parking spaces and parking meters.

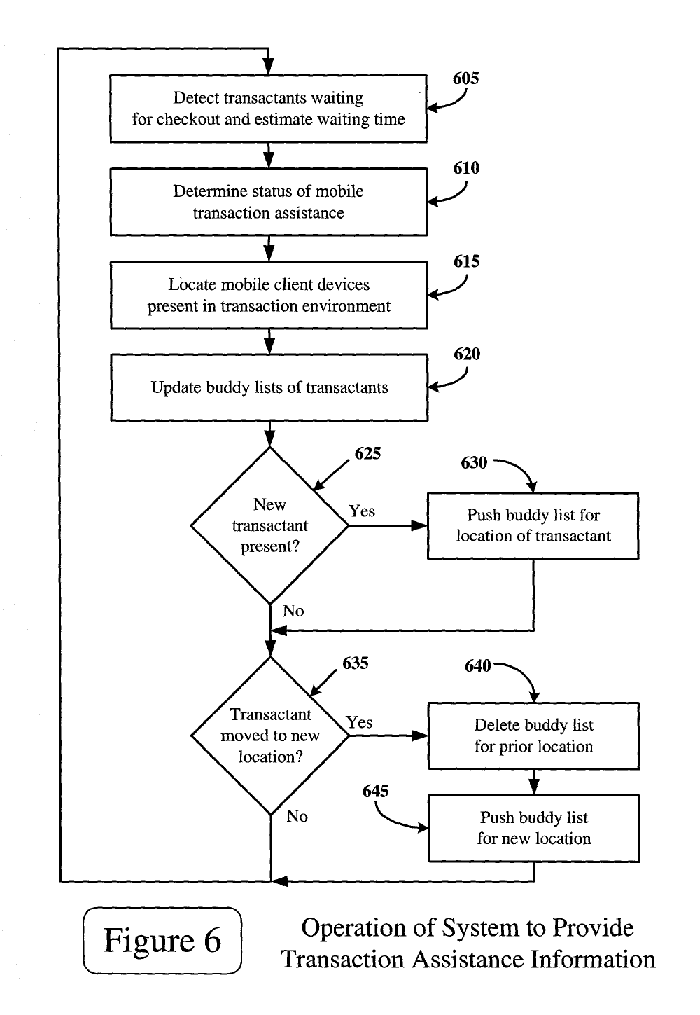

FIG. 6 is a block diagram illustrating the operation of a particular embodiment of the invention. The block diagram is intended to illustrate certain functions of an embodiment of the invention and is not intended to describe the order of such functions or the particular manner in which the functions may be performed. Under the embodiment, transactants who are waiting in line for checkout in the transaction environment are detected and, based at least in part on the detected numbers, estimated waiting times are calculated, process block 605. Under some embodiments, the status of mobile transaction assistance, such as transaction assistants who are not located at transaction stations, is determined, process block 610. In order to determine the location of transactants in the transaction environment, mobile client devices present in the transaction environment are located, process block 615.

Using the transaction assistance data that has been determined, buddy lists of transactants who have been present in the store are updated on the mobile client devices possessed by such transactants, process block 620. The buddy list information is information concerning transaction assistance availability, including, for example, information regarding which transaction stations are open, how many transactants are waiting in line for check out at each transaction station, and the estimated waiting time at each transaction station. The information may also include information regarding the availability of mobile transaction assistance, such as, the availability of salespeople in a retail store. If a new mobile client device is detected indicating the arrival of a new transactant in the transaction environment, process block 625, buddy list information regarding sale assistance availability is pushed to the mobile client device of the transactant, process block 630. Under certain embodiments, if the detection of mobile client devices in the transaction environment indicates that a transactant has moved to a new location in the transaction environment, process block 635, the buddy list information for the prior location of the transactant is deleted, process block 640, and buddy list information for the new location of the transactant is pushed to the mobile client device of the transactant, process block 645. For example, in a large store different transaction assistance information may be provided or information may be provided in a different format as the transactant moves to a different department or to different floor of the store.

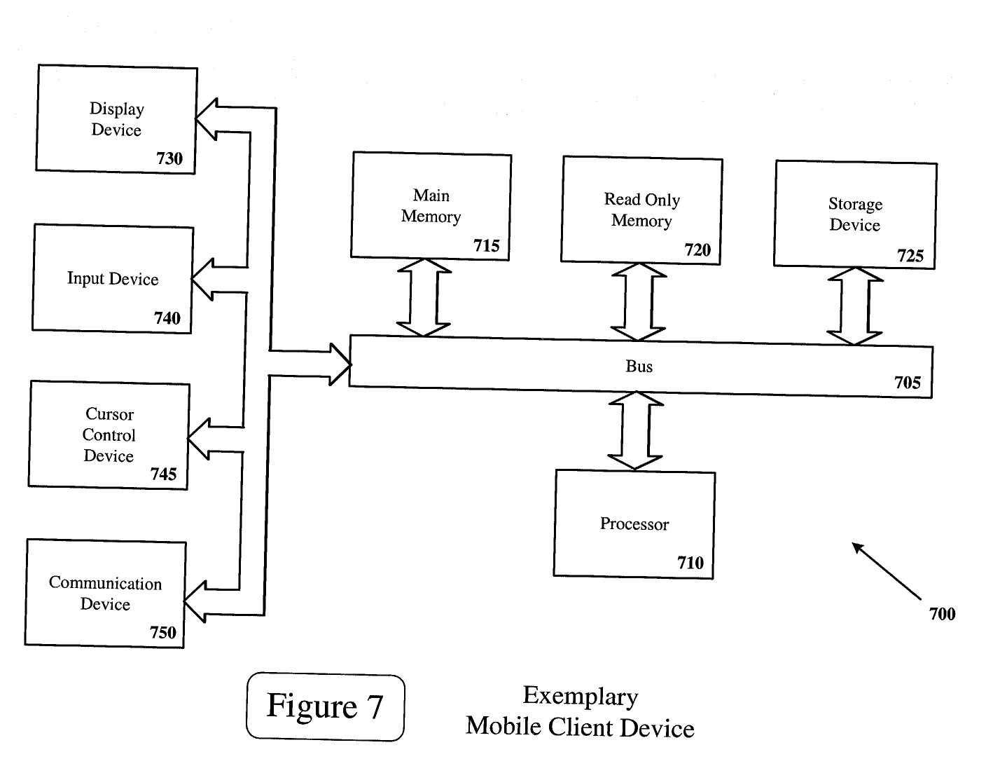

FIG. 7 is a block diagram illustrating an exemplary mobile client device that may be utilized under an embodiment of the invention. Not all mobile client devices are structured as shown in FIG. 7. In addition, certain mobile client devices may utilize elements shown in FIG. 7 as auxiliary devices that are external from the mobile client device. Under an embodiment of the invention, a mobile client device 700 comprises a bus 705 or other communication means for communicating information, and a processing means such as a processor 710 coupled with the bus 705 for processing information. The mobile client device 700 further comprises a random access memory (RAM) or other dynamic storage device as a main memory 715 for storing information and instructions to be executed by the processor 710. Main memory 715 also may be used for storing temporary variables or other intermediate information during execution of instructions by the processor 710. The mobile client device 700 also may comprise a read only memory (ROM) 720 and/or other static storage device for storing static information and instructions for the processor 710.

A data storage device 725 may also be coupled to the bus 705 of the mobile client device 700 for storing information and instructions. The data storage device 725 may include a magnetic disk or optical disc and its corresponding drive, flash memory or other nonvolatile memory, or other memory device. The mobile client device 700 may also be coupled via the bus 705 to a display device 730, such as a liquid crystal display (LCD) or other display technology, for displaying information to an end user. In some environments, the display device may be a touch-screen that is also utilized as at least a part of an input device. In some environments, display device 730 may be or may include an auditory device, such as a speaker for providing auditory information. An input device 740 may be coupled to the bus 705 for communicating information and/or command selections to the processor 710. In various implementations, input device 740 may be a keyboard, a keypad, a touch-screen and stylus, a voice activated system, or other input device, or combinations of such devices. Another type of user input device that may be included is a cursor control device 745, such as a mouse, a trackball, or cursor direction keys for communicating direction information and command selections to processor 710 and for controlling cursor movement on display device 730.

A communication device 750 may also coupled to the bus 705. Depending upon the particular implementation, the communication device 750 may include a transceiver, a wireless modem, a network interface card, or other interface device. The mobile client device 700 may be linked to a network or to other devices using the communication device 750, which may include links to the Internet, a local area network, or another environment.

The invention has been described in terms of several embodiments. However, those of ordinary skill in the art will recognize that the invention is not limited to the embodiments described, but rather that modifications and changes may be made without departing from the broader spirit and scope of the invention. The specification and drawings are thus to be regarded as illustrative rather than limiting.

What is claimed is:

1. A mobile device comprising:
a communication link to a service provided in a transaction environment, the service to provide information concerning transaction assistance availability in the transaction environment; and
a display device, the display device to provide a display based at least in part on the information concerning transaction assistance availability.

2. The mobile client device of claim 1, wherein:
the service locates the mobile device in the transaction environment; or
the mobile client device detects the service in the transaction environment and informs the service regarding the location of the mobile client device.

3. The mobile client device of claim 1, wherein the information includes information regarding whether a transaction station is open.

4. The mobile client device of claim 3, wherein the information includes information regarding the number of transactants waiting for service at the transaction station.

5. The mobile client device of claim 4, wherein the information includes an estimated waiting time for service at the transaction station.

6. The mobile client device of claim 5, wherein the information includes information regarding the availability of a transaction assistant to provide assistance.

7. A transaction assistance information system comprising:
a wireless network in a transaction environment; and
a connection point, the connection point to provide a communications link with a mobile client device that is located within the transaction environment, the wireless network to provide information regarding availability of transaction assistance to the mobile client device.

8. The transaction assistance information system of claim 7, wherein the information regarding availability of transaction assistance includes information regarding whether a transaction station is currently in operation.

9. The transaction assistance information system of claim 8, wherein the information regarding availability of transaction assistance includes information regarding the number of transactants waiting for service at the transaction station and the estimated waiting time for service at the transaction station.

10. The transaction assistance information system of claim 9, further comprising a detector to determine the number of transactants waiting for service at the transaction station.

11. The transaction assistance information system of claim 7, wherein the information regarding availability of transaction assistance includes information regarding the availability of transaction assistants to assist transactants in the transaction environment.

12. The transaction assistance information system of claim 7, wherein the wireless local area network utilizes an instant messaging system.

13. The transaction assistance information system of claim 12, wherein the information regarding availability of transaction assistance is provided as a buddy list or as a supplement to a buddy list, the buddy list including transaction assistants in the transaction environment.

14. A transaction assistance information system comprising:
a means for locating a mobile client device of a transactant in a transaction environment;
a means for determining transaction assistance availability for the transactant; and
a means for providing information regarding transaction assistance availability to the mobile client device.

15. The transaction assistance information system of claim 14, wherein the means for determining transaction assistance availability comprises:
a means for determining a number of transactants who are in line for service at a transaction station; and
a means for estimating the time required to wait for transaction assistance at the transaction station.

16. The transaction assistance information system of claim 14, wherein the means for determining transaction assistance availability comprises:
a means for determining the availability of transaction assistants to assist a transactant.

17. The transaction assistance information system of claim 14, wherein the means for locating a mobile client device includes a means for determining in which of a plurality of regions in the transaction environment the mobile client device is located.

18. The transaction assistance information system of claim 17, wherein the transaction assistance information system provides information that is based at least in part on the region in which the mobile client device is located.

19. A method comprising:
determining the location of mobile device in a transaction environment;
determining the availability of transaction assistance in the transaction environment; and
transmitting information regarding availability of transaction assistance to the mobile device.

20. The method of claim 19, wherein the information regarding availability of transaction assistance includes information regarding whether a transaction station is currently open.

21. The method of claim 20, wherein the information regarding availability of transaction assistance includes the number of transactants waiting for service at the transaction station.

22. The method of claim 21, wherein the number of transactants waiting for service at the transaction station is determined automatically.

23. The method of claim 22, wherein the information regarding availability of transaction assistance includes an estimated waiting time for service for the transaction station.

24. The method of claim 19, wherein the transaction environment is a retail store.

25. A machine-readable medium having stored thereon data representing sequences of instructions that, when executed by a processor, cause the processor to perform operations comprising:
determining the location of mobile device in a transaction environment;
determining the availability of transaction assistance in the transaction environment; and
transmitting information regarding availability of transaction assistance to the mobile device.

26. The medium of claim 25, wherein the information regarding availability of transaction assistance includes information regarding whether a transaction station is currently open.

27. The medium of claim 26, wherein the information regarding availability of transaction assistance includes the number of transactants waiting for service at the transaction station.

28. The medium of claim 27, wherein the number of transactants waiting for service at the transaction station is determined automatically.

29. The medium of claim 28, wherein the information regarding availability of transaction assistance includes an estimated waiting time for service for the transaction station.

30. The medium of claim 25, wherein the transaction environment is a retail store.
